(19) United States
(12) Patent Application Publication
(10) Pub. No.: US 2004/0138971 A1
(43) Pub. Date: Jul. 15, 2004

(54) Barter intermediation-prepayment trust

(76) Inventor: Ted B. Helms, Knoxville, TN (US)

Correspondence Address: PITTS AND BRITTIAN P C, P O BOX 51295, KNOXVILLE, TN, 37950-1295, US

(21) Appl. No.: 10/342,899

(22) Filed: Jan. 15, 2003

(51) Int. Cl. G06F 17/60

(52) U.S. Cl. 705/35

(57) ABSTRACT

Many typical Vendor/Buyer relationships present long term business situations, either contractual or non-contractual, that offer predictable cash flows over a defined period. Some Vendors, anxious to obtain these supply relationships, may have aggressively expanded their assets, resulting in excessive balance sheet leverage. It is the purpose of the BIP Trust to provide a mechanism whereby the supply relationship cash flows can be approximately matched with undervalued Vendor Capital Obligation maturities to capture Intermediation Profits through the barter of these Obligations in settlement of supply invoices. Capital markets often undervalue long term supply Contracts that the Buyer is in a unique position to confidently assess the value and the performance risks. The Vendor and Buyer, by explicitly linking some or all of these relationship cash flows, which may be significantly under-appreciated by the capital markets, with the Vendor's undervalued Obligations, have the opportunity to capture Intermediation Profits. Contrasted to a contract monetization that takes profit out of a supply relationship, it is the purpose of the BIP Trust to capture value from the capital markets while leaving intact the profit potential of the supply relationship.

### CROSS REFERENCE TO RELATED APPLICATIONS

Not applicable

### STATEMENT REGARDING FEDERALLY SPONSORED RESEARCH OR DEVELOPMENT

Not applicable

### FIELD OF INVENTION

The present invention is related generally to the structuring of financial transactions. More particularly, the present invention is directed toward a method of forming a barter-intermediation-prepay mechanism to intermediate the cost of capital between a vendor and a buyer engaged in a supply relationship; or, to intermediate the cost of capital between the vendor and the capital markets. The transaction is based upon the value of the contract between the vendor and the buyer in the supply relationship.

### CONSTRUCTION OF DEFINITIONS AND USE THEREOF

Definitions herein created are denoted by “holding” the term so defined and later capitalized where the defined term in intended to be used, as in Bolding. The defined term shall generally be described by the sentence, but more likely the paragraph in which the defined term so appears. For the sake of clarity, the definition shall be more broadly, or more narrowly as the case may be, modified later in the specification as additional explanation is provided. All terms so defined are used as such in the specification hereinafter, in the claims, and in the Abstract. The word “or” is used herein in its broadest sense as an inclusive logical operator, which includes both or all choices.

### BACKGROUND OF THE INVENTION

A substantial portion of global commerce between businesses is conducted with vendor/buyer relationships, often formalized through the use of long-term supply agreements. An important reason these supply agreements are formalized is that capital markets can have the assurance that commercial arrangements have been made to provide predictable long-term cash flows, which in turn, will provide regular returns on the capital invested. In many instances, the long-term contract may be an extension of a strategic asset location, a dominant market position, or other favorable business factor, and may not have been mandated by the capital markets. Nevertheless, it is these supply relationships, either formal or informal, for the purchase and sale of goods and services (hereinafter “Contract”, which will encompass both the singular and plural case), that give investors, lenders, and all who furnish capital to businesses or who rely upon their credit, the confidence that sufficient commercial activity will be generated to provide the cash flow necessary to satisfy debt repayment, provide equity holders with a return, and allow the business to grow and prosper.

Most industries, especially capital intensive ones, have Contract forms which have evolved over time and may be similar throughout that industry. Some industries' Contracts have become so standardized that their Contracts have been securitized, take for example natural gas production or agriculture, where many of the supply agreements are conducted through the use of commodity futures contracts. These commodity markets provide an excellent illustration of a supply relationship where the Contract or long-term price may become exaggerated versus the “spot” price due to the future perception of supply and demand balance. In a situation where the Contract price has risen substantially above the spot price, then the Contract begins to have “Supply Value” (as opposed to a below market Contract with “purchase value”) which is defined as the present value of the excess over the market or spot price; moreover, this Supply Value may be magnified by either the length of the Contract term or a larger degree of disparity between the spot and Contract prices. Therefore, what is needed is a method of providing both the vendor and buyer an opportunity to profit from their familiarity with a Contract's high Supply Value, which the credit markets may have significantly under valued due to a lack of understanding, and such valuation is manifested in the low price of the vendor's debt.

### SUMMARY OF THE INVENTION

The simplest and preferred embodiment of this invention is directed toward a method of establishing a barter-intermediation-prepay trust to fund a prepayment of purchases under a long-term supply Contract between a buyer and a vendor wherein the vendor has a higher cost-of-capital than the buyer, possibly to an extreme. Preferably, the long-term Contract requires the buyer to purchase goods at a value in excess of the value of the goods or services in the spot market. The method commences with the establishing of a mechanism, which for the purposes of the discussion herein shall be referred to as a “Trust” (hereinafter BIP Trust or Trust, which shall be used interchangeably) to accept a prepayment from the buyer relating to the future performance under the Contract. The buyer funds the prepayment from its own sources of capital or by issuing securities in the capital markets. The prepayment funds are employed to purchase bonds of the vendor at a discounted price. The vendor's bonds that are held by the BIP Trust will earn an intermediation interest spread because the vendor has a higher cost of capital than the prepayment fund source. This interest spread coupled with the capital gains from the bond purchase cost versus the bond barter value combines to form the Intermediation Profit of the BIP Trust. Invoices for purchases under the Contract are settled by the buyer taking credit against its prepayment to the Trust, and then the Trust discharges its invoice obligation by bartering the vendor's bonds in settlement. These Intermediation Profits are shared according to the contractual BIP Trust mechanism put in place by the vendor and buyer.

The above described embodiment provides the obviously advantageous opportunity for both the buyer and the vendor to earn an Intermediation Profit from an existing contract having a high Supply Value. The profit potential so created does not disturb the vendor's profit potential under the Contract that would obviously be impaired by monetizing the agreement. The invention captures value from the capital markets by arbitraging costs of capital using an underlying Contract, as opposed to taking value out of the Contract by monetizing it. There are numerous alternate structures and mutations of the invention that adapt it to the particular circumstances of the vendor, the buyer, related parties of each, the Contract, and the capital markets. In addition, the purchasing of the vendor's bonds may increase the value of the vendor's debt in general and, thus, enhance the vendor's credit standing and the ability of the vendor to raise funds in the securities markets. Therefore, this invention improves upon the prior art.

### BRIEF DESCRIPTION OF THE DRAWINGS

FIG. 1 is a flow chart showing the basic process of the BIP Trust concept in accordance with the simplest embodiment of the present invention;

FIG. 2 is a block diagram illustrating the structural phase of a buyer funded BIP Trust in accordance with the simplest and preferred embodiment of the present invention;

FIG. 3 is a block diagram illustrating the intermediation setup phase of a buyer funded BIP Trust in accordance with the simplest and preferred embodiment of the present invention;

FIG. 4 is a block diagram illustrating the intermediation phase of a buyer funded BIP Trust in accordance with the simplest and preferred embodiment of the present invention;

FIG. 5 is a block diagram illustrating the contract performance and barter phases of a buyer funded BIP Trust in accordance with the simplest and preferred embodiment of the present invention;

FIG. 6 is a block diagram illustrating the accounting and settlement phase of a buyer funded BIP Trust in accordance with the simplest and preferred embodiment of the present invention;

FIG. 7 is a block diagram illustrating the structural phase of a third party funded BIP Trust in accordance with an alternate embodiment of the present invention;

FIG. 8 is a block diagram illustrating the intermediation setup phase of a third party funded BIP Trust in accordance with an alternate embodiment of the present invention;

FIG. 9 is a block diagram illustrating the intermediation phase of a third party funded BIP Trust in accordance with an alternate embodiment of the present invention;

FIG. 10 is a block diagram illustrating the contract performance and barter phase of a third party funded BIP Trust in accordance with an alternate embodiment of the present invention;

FIG. 11 is a block diagram illustrating the accounting and settlement phase of a third party funded BIP Trust in accordance with an alternate embodiment of the present invention;

FIG. 12 is a block diagram illustrating the setup phase of a DWR/IPP BIP Trust in accordance with a specific industry embodiment of the present invention;

FIG. 13 is a block diagram illustrating the intermediation setup phase of a DWR/IPP BIP Trust in accordance with a specific industry embodiment of the present invention;

FIG. 14 is a block diagram illustrating the intermediation phase of a DWR/IPP BIP Trust in accordance with a specific industry embodiment of the present invention;

FIG. 15 is a block diagram illustrating the contract performance and barter phase of a DWR/IPP BIP Trust in accordance with a specific industry embodiment of the present invention; and

FIG. 16 is a block diagram illustrating the accounting and settlement phase of a DWR/IPP BIP Trust in accordance with a specific industry embodiment of the present invention.

### DETAILED DESCRIPTION

When product prices in an industry become very cheap relative to the cost of production, frequently the supply Contracts in that industry assume more value than the “hard” producing assets. Lenders may pressure a vendor, who in this situation is highly leveraged, to capture some of this excess Supply Value in order to reduce debt levels. Alternatively, the buyer may be anxious to purchase the Contract from the Vendor because the buyer may have another supply source with lower costs than the present vendor, thus, the buyer's Supply Value computation may even be higher than the vendor's. Often the vendors, in extreme situations, may see their public debt reduced to “junk” status as a result of highly depressed spot markets; thus, the pressure by creditors to monetize highly valued Contracts may become intense.

Many monetization situations offer “win-win” scenarios for the vendor/buyer relationship because they provide an opportunity to arbitrage between the relative capital cost discount rates of the parties. The vendor, who now has a high business risk profile stemming from extreme leverage and low spot prices, has seen its debt reduced to junk ratings, often with very high yields to maturity. Without getting into a detailed theoretical discussion on weighted average “Cost of Capital” (hereinafter COC) computations, Table 1 provides an example that arbitrages a Contract with high Supply Value at highly disparate COC rates. Natural gas prepay agreements, which are done with or without excess Supply Value, have their cornerstone on the concept of arbitraging cost of capital differentials between a vendor and a buyer (1).

“IRS May Kill Bright Idea Generated by Utility Firm”, WSJ.com Sep. 23, 2002 by Andrew Caffrey.

TABLE 1
Cost of Capital Arbitrage Value

| | | Projected | Spot | | Present | Present | “COC” |
|---|---|---|---|---|---|---|---|
| | Contract | Spot | Price | Supply | Value | Value | Arbitrage |
| | Revenue | Price | (total) | Value | Vendor | Buyer | Value |
| Year | (mils $) | (per unit) | (mils $) | (mils $) | (mils $) | (mils $) | (mils $) |
| 1 | $983.4 | $31.00 | $511.5 | $471.9 | $390.0 | $447.3 | |
| 2 | $983.4 | $31.50 | $519.8 | $463.7 | $316.7 | $416.6 | |
| 3 | $983.4 | $32.00 | $528.0 | $455.4 | $257.1 | $387.8 | |
| 4 | $983.4 | $33.00 | $544.5 | $438.9 | $204.8 | $354.3 | |
| 5 | $983.4 | $34.00 | $561.0 | $422.4 | $162.9 | $323.2 | |
| 6 | $983.4 | $35.00 | $577.5 | $405.9 | $129.3 | $294.4 | |
| 7 | $983.4 | $35.00 | $577.5 | $405.9 | $106.9 | $279.0 | |
| total | | | | $3,064.1 | $1,567.6 | $2,502.6 | $935.0 |

Assumptions for Table 1:
Contract Term = 7 years
Contract Units Per Year = 16,500,000
Price Per Contract Unit = $59.60
Vendor Weighted Average
Capital Cost = 21.0%
Buyer Weighted Average
Capital Cost = 5.5%
Projected Spot Price over Term = See below

It can be seen that comparing the vendor and buyer computations of the Supply Value provides both parties with an opportunity to profit from the disparities between their respective COC (hereinafter “COC Arbitrage”). Alternatively, natural gas prepay agreements generally discount the total Contract revenue or cost, as opposed to just the Supply Value discount computation above, when determining the COC Arbitrage value because these gas prepay contracts are based upon long term market prices and have no Supply Value as defined herein. Obviously, the example above demonstrates a situation highly unbalanced in favor of the vendor. However, the parties to the relationship should look beyond the high Supply Value to the second value component present here, which is the COC Arbitrage Value. If the parties are motivated to “unlock” value from these two components, what is the optimum approach to do so?

The usual disadvantage associated with monetizing a contract is that this is a static, or point in time, approach to solving a dynamic problem, which by its very nature is usually structured to have a long life. Industries that conduct a high proportion of their commerce under long term agreements frequently experience Contract monetization. Because the dominant position of a lender, group of lenders, or credit rating agency often dictate how a deal may be structured or the use of proceeds, the deal may favor the priority creditors but be to the detriment of others, including less senior creditors, employees, equity holders, and even the buyer. Other disadvantages of Contract monetization include the discounting of future profits at a very high interest rate, even when the prospects of the vendor may be improving; thus, while the near term risk of the vendor survival may improve, the long term prospects of the vendor would likely be diminished. Furthermore, the act of pulling future profits into the present may not only accelerate tax liabilities, but may ultimately cause a business to pay more total lifetime taxes. The formation of a BIP Trust, in accordance with the present invention, allows the vendor and buyer to surmount these monetization disadvantages by employing Supply Value as the foundation on which to underwrite a COC Arbitrage opportunity; thus, the parties create incremental, ongoing profit for their relationship, as opposed to taking profit out of the relationship through a Contract monetization.

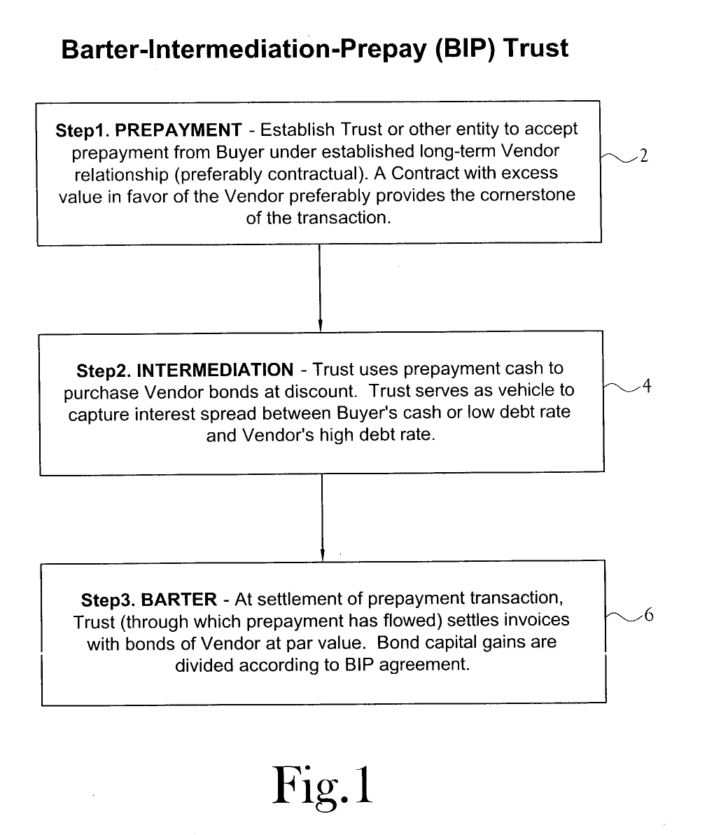

The rationale for the BIP Trust is to structure a dynamic solution to the challenges (and opportunities) created by the combination of a highly leveraged vendor, a Contract with high-imputed Supply Value, and an attractive COC Arbitrage opportunity. FIG. 1 sets forth the most basic concept of the BIP Trust. Step 1, as set forth in block 2, is to establish a Trust or mechanism suitable to the situation of the parties, or even a contractual arrangement whereby prepayment is formalized under a long-term supply relationship. The actual agreement setting forth the terms of the prepayment will hereinafter be defined as the “Prepay”. It would be desirable if the Prepay were in a form that is recordable such that the holder of the Prepay has a secured interest in that specific Contract transaction. This Prepay agreement may be the same agreement that creates the Trust mechanism or it may be a separate agreement. The Prepay would likely amend the Contract and would also likely alter the Contract invoicing process. Such action of creating the Prepay or its funding could require approval or some type of consent by the lenders of the vendor and possibly of the buyer, since it is possible that a security interest in the Contract may have to be granted under the Prepay and held by the Trust to facilitate the transaction. The mechanisms of performing Steps 2 and 3, as set forth in blocks 4 and 6, must be incorporated into Step 1 in the initial contractual process, but occur later. Cash is provided by the buyer, or other party, to fund the Trust (this will be discussed in more detail later) to accomplish the prepayment transaction. The Trust uses the funding to purchase the debt of the vendor at depressed market prices. In present credit market conditions, this could be at high discounts, easily 20% to 30%, and in extreme cases such as merchant power production or telecommunications, this could be at 40% to 60% discounts. Immediately the Trust begins earning an intermediation return on the vendor debt, which is the difference in the cost of funds provided to the Trust and the purchased yield of the vendor debt. Step 3 is the barter phase of the Trust where inventoried bonds are used to settle invoices under the Contract relationship. This phase will provide a capital gain to the Trust or vendor, depending on the BIP Trust contractual arrangement initially put in place. Obviously, tax considerations will impact the Trust's initial structure and operation.

The BIP Trust may take any one of several forms with the objective being to create a synergistic profit opportunity for the vendor and buyer engaged in a Contract having Supply Value. Again, the purpose of the BIP Trust is to serve as the intermediary, linking the Contract relationship cash flows with undervalued vendor debt in order to achieve Intermediation Profits. Some of the potential forms to establish this mechanism include: (a) a standard corporation, (b) alternate corporate forms such as Subchapter “S”, (c) partnership, (d) an actual trust entity (as distinguished from the defined use of Trust herein), (e) escrow account and agent to perform Trust services, or (f) a contractual entity in form only using an agent to perform the services of the BIP Trust. An example of an alternate corporation form would be a Real Estate Investment Trust in a situation where the discounted debt of the vendor that is being intermediated consists of first mortgage bonds. The process of matching undervalued debt maturities with contract cash flows exploits the risk adversity that capital markets often overplay. This cooperative act of structuring the BIP Trust seeks to capture this “mis-valuation” opportunity before the market correctly assesses the risk versus reward tradeoff. Not only do security markets often undervalue Contracts with high Supply Value because of a lack of understanding or because of associated leverage risk, but these Contracts may have additional perceived risk because it is believed that the buyer will seize any possible chance to break the Contract. Further, if the vendor is in a weakened financial state due to extreme leverage, this also presents a vendor performance default risk toward realizing the Contract's inherent value. Creation of the BIP Trust improves upon the prior art by reducing performance risk, both from the standpoint of the vendor and buyer, and thereby raises the likelihood of Contract fulfillment.

The ideal situational characteristics for a BIP Trust are provided in Table 2 below.

TABLE 2
Ideal Situational Characteristics for BIP Trust

```
1. A long term relationship between a “Vendor”, who is
the supplier of goods or services under a Contract, and
a “Buyer”, who is the purchaser under the Contract, such
relationship is predictable (preferably contractual) and can be
monetized. The definition of Vendor and Buyer encompass both
the singular and plural cases where there could be multiple
Vendors (or vice versa) involved collectively in a BIP
Trust transaction.
2. Vendor/Buyer Relationship:
  a. For Vendor, as compared to market standard, must have dominant,
  obvious, or high Supply Value
  b. For Buyer, must be assumable or easily replaceable by Vendor's
  competitors
3. Vendor's credit situation is characterized by:
  a. Substandard credit rating, and
  b. Publicly traded bonds sell at substantial discounts
4. Buyer has either or both strong credit and access to low cost money
```

5. Vendor bond maturities can be relatively easily matched to Contract relationship cash flow.

Table 2 is provided to facilitate understanding of the BIP Trust concept and when it may be most profitably employed. Naturally, as in most commercial concepts, the “ideal” is rarely the case. Thus, it is understood that the present invention as set forth in FIG. 1 can be utilized in a variety of applications, not just the “ideal”. As discussed in the foregoing, a long-term supply relationship that is contractual is preferred. If the relationship is not contractual, it must, through its nature promote a strong informal relationship bond or loyalty (for example, a critical raw material supplier who has substantial logistic cost advantages versus the competition). If the relationship is informal, the use of the BIP Trust will, as a matter of necessity, require that a level of contractual formality be created versus that which already exists. The nature of the relationship, from the Vendor's standpoint, will be that its product or service will have Supply Value originating from the Contract or from some dominant market feature (location, design, unique specification, etc.). From the Buyer's viewpoint, the relationship will best be characterized as being assumable or easily replaceable by the instant Vendor's competition; or, in the dominant market case, by the Buyer being granted contractual rights to assume the Vendor's production capability.

In order to maximize the Intermediation Profits of the Trust, it is desirable that the Vendor has a substandard credit rating and very high debt cost; moreover, at the other extreme, the Buyer would ideally have either a very strong credit rating and/or access to inexpensive funding. This ideal situation presents the maximum ability to profit from the COC Arbitrage between the Vendor and the Buyer. Because, funding may come from sources other than the Buyer, it is not imperative that the Buyer be highly credit worthy, particularly in instances where the Contract relationship has a very large Supply Value that may be fungible. In other words, a less than ideal COC Arbitrage value (for example, the buyer's debt cost is very similar to the Vendor's) can still provide a highly desirable BIP Trust opportunity if the Supply Value is extreme because this offers opportunity to greater secure the Prepay. In this instance, funding may be provided by a third party that can provide lower cost money than the buyer in order to establish a favorable COC Arbitrage. The Supply Value and the COC Arbitrage value are somewhat complementary, and in the reverse of the foregoing, a very high COC Arbitrage value would work well with little or no Supply Value.

Finally, the fifth and final ideal characteristic is that the Vendor's bond maturities can be easily matched to the Contract relationship cash flows. Unfortunately, the world is not always ideal, and when the bond maturities do not exactly match the relationship cash flows, then one of the parties involved in the transaction will have a “liquidity penalty” (in the case of a vendor who may accept bonds pre-maturity) or a bond “inventory cost” (in the case of the Trust who must settle invoices with post matured bonds). Nevertheless, when the parties have identified sufficient economic potential in the BIP Trust transaction, through matching the Supply Value with the COC Arbitrage process, these additional costs for liquidity or inventory, which will absorb some of the BIP Trust profit potential, will have to be incorporated into the Trust business model.

The structuring of a BIP Trust should provide a dynamic solution to using the Supply Value to capture the COC Arbitrage opportunity through its creative application. The BIP Trust will generate two basic pieces of Intermediation Profits: earning a “spread” between the costs of funds furnished the Trust and the purchased obligation yields; second, capital gains income from the purchased obligation cost basis versus the invoice settlement basis allowed under the BIP Trust Agreement. The allocation of both types of profit is up to the creative choices of the parties to the agreement, and may even provide for “dividend” profits to non-agreement entities depending on the dynamics of the Contract. For example, a Vendor credit institution may have negative loan covenants that would prohibit the Prepay and would have to be induced to approve the transaction by participating in the bartered bond discounts. In addition, the allocation of profits may moderate over time subject to a variety of factors which may include but not be limited to: the COC Arbitrage between the parties lessens over time as either the Vendor's or Buyer's credit rating or circumstance change; the tax circumstances of each individual party; or, change in market climate which may impact the degree of Supply Value. It should be stressed that the BIP Trust may be as flexible or inflexible in its contractual terms or operation as the parties' structural desires or as the business circumstances of those parties may impose.

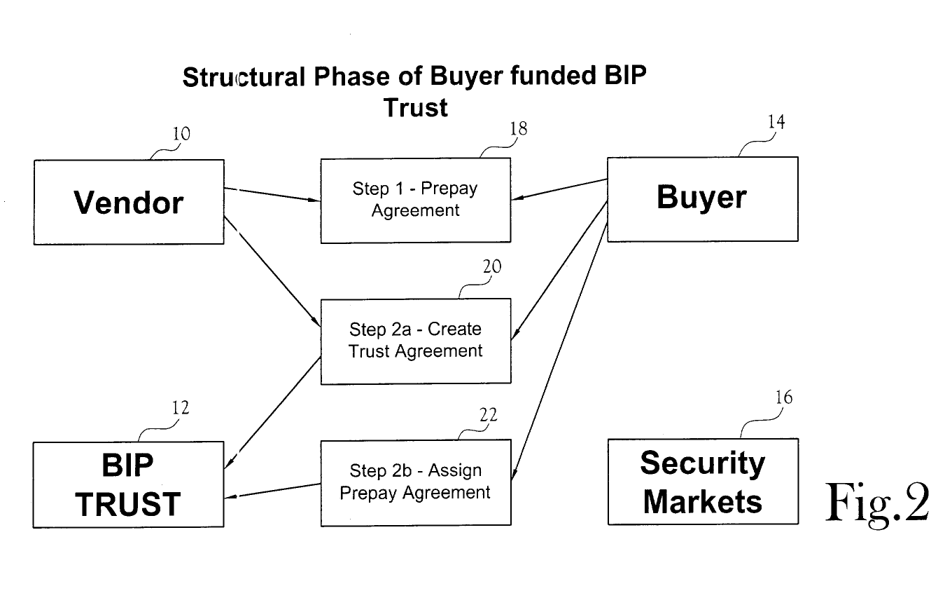

FIG. 2 provides the most straightforward BIP Trust structure, which is the “Buyer Funded” structure. The structural phase of the Trust is as follows: Step 1: the Vendor 10 and Buyer 14 enter into the Prepay as an amendment to an already formalized Contract as shown in block 18; further such amendment provides for the settlement of future invoices using matured debt of the Vendor 10. This process of “bartering” debt for invoice obligations may include and is most easily transacted using publicly traded bonds of the Vendor 10, but could include bank debt, other debt, or hybrid obligations of the Vendor 10, possibly introducing a lender as a party to the Prepay (and/or the Trust Agreement) as previously discussed. Steps 2a and 2b: The Vendor 10 and Buyer 14 enter into a BIP Trust agreement that creates an appropriate entity as the assignee of the Prepay as shown in blocks 20 and 22; furthermore, the Buyer 14 commits to a funding level of the Trust 12. It is through the commitments in these two agreements, the Prepay 18 and the Trust 20 (or they may be one combined agreement), that the parties allocate the Intermediation Profits, that is the interest spread and the capital gains; moreover, it should be specified where and how profits are taken—either in the Trust 12 or by the parties themselves, taken by discounting the invoices rendered or the so bonds tendered. The structural phase of the BIP Trust may have widespread contractual ramifications for either the Vendor 10 or Buyer 14 on their other existing commercial arrangements, particularly credit agreements. If the Trust 12 is to be operated independently (as opposed to being operated by one of the parties), then some level of equity contribution may be necessary to set up Trust “housekeeping”.

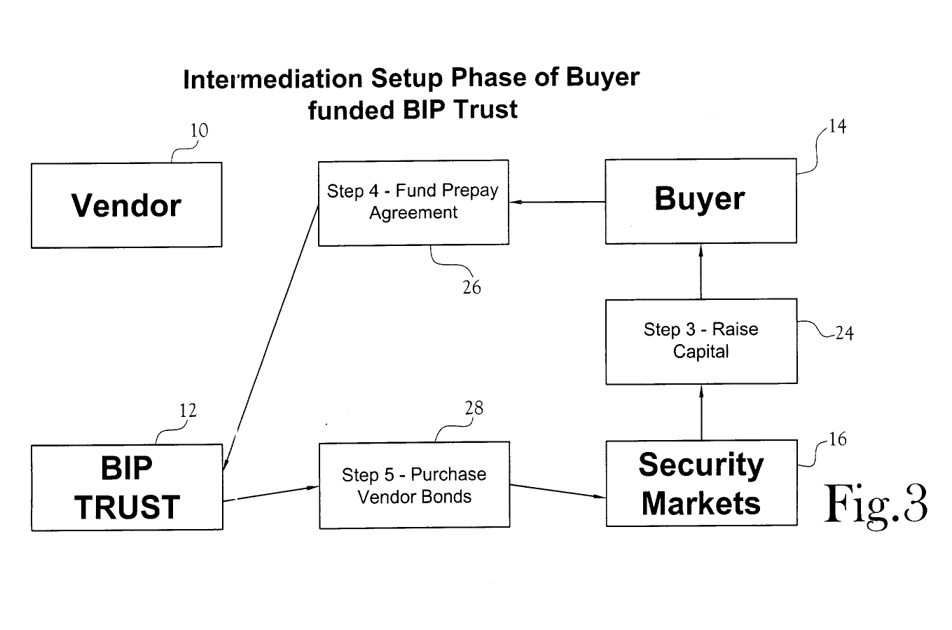

The Intermediation Setup Phase of the Trust commences with Step 3 as shown in block 24 of FIG. 3. The Buyer 14 funds the Trust 12 through its available liquidity or through an issue of securities in the security markets 16, more than likely debt, to satisfy the Prepay obligation. Step 4, block 26: the proceeds from the security issuance are used to fund the Prepay commitment. Should the Buyer 14 be highly liquid or have ample borrowing ability, then it may fund the Prepay 26 through cash or borrowing capacity on hand. Step 5, block 28: the Trust 12 enters the capital markets 16 and purchases bonds of the Vendor 10.

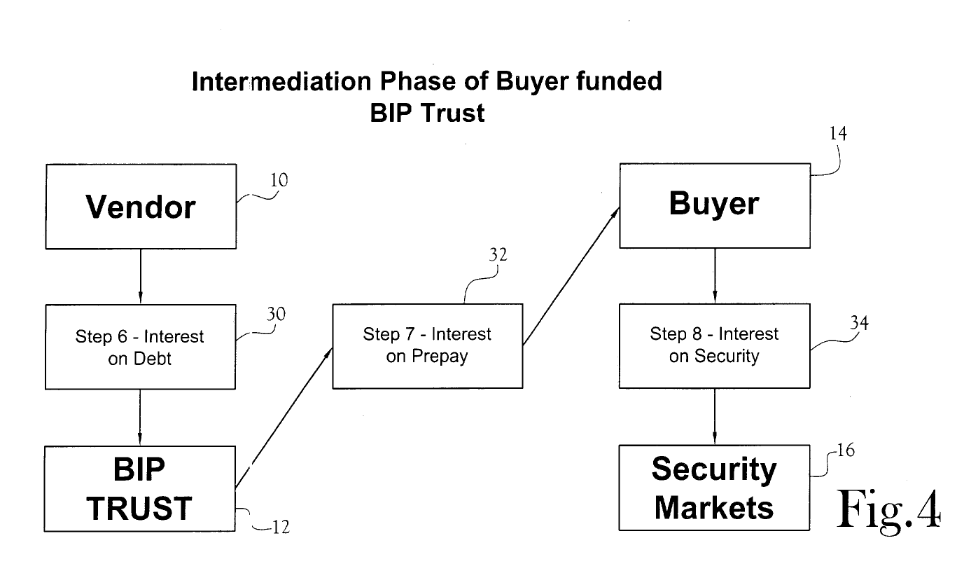

The Intermediation Phase of the Trust commences with Step 6: as shown in block 30 of FIG. 4. In block 30, the Vendor 10 makes its periodic interest payments to the Trust 12 as holder of the bonds. Step 7, block 32: The Trust 12 makes its periodic interest payments on the Prepay of the Buyer 14, or the Buyer 14 effectively realizes its interest by discounting invoices, depending on the methodology specified in the Trust and/or Prepay agreement(s). Step 8, block 34, the Buyer 14 pays interest on the securities issued to fund the prepayment.

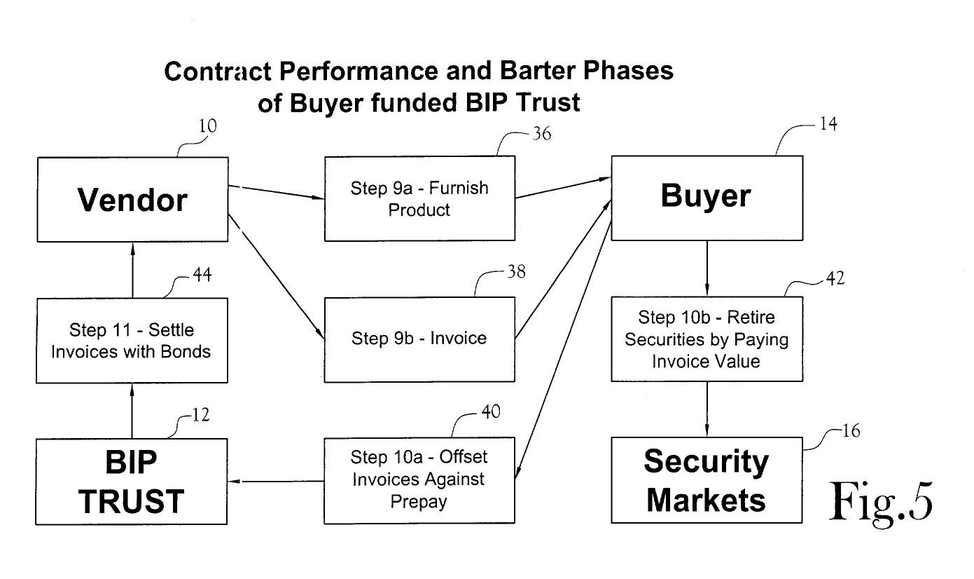

The Contract Performance Phase shown in FIG. 5 commences with Steps 9a and 9b in blocks 36 and 38: The Vendor 10 furnishes product or service 36 to the Buyer 14 as provided under the Contract and invoices 38 Buyer 14 for same. Steps 10a and 10b in blocks 40 and 42: Instead of paying for invoices subject to the Prepay, the Buyer 14 offsets the invoice against his prepayment credit 40, and in the case where the Buyer 14 has raised outside capital (and the securities may be linked to the BIP transaction) to facilitate the Prepay, the invoice value is paid to retire security principle 42. The option of directly linking securities to the BIP Trust transaction will be discussed in greater hereinafter. Step 11 shown in block 44 represents the Barter Phase of the BIP Trust transaction: The Trust 12, when notified of such specific invoice credit, settles the invoice with Buyer 14 by furnishing a bond 44, or other security instrument that the Trust 12 has acquired. The Vendor 10 may, by agreement, elect to take some of its profit by accepting bonds at a discount only, as opposed to par, depending upon terms of the Trust and/or Prepay agreements.

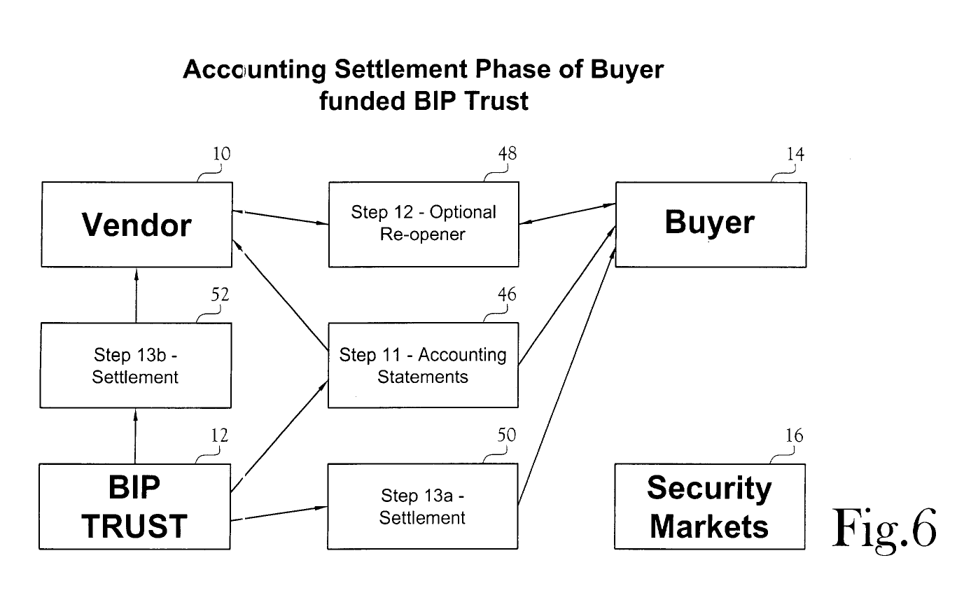

The last three steps of the simplest and preferred embodiment represent the Accounting/Termination Phase of the process and are shown in FIG. 6. Step 11: At periodic accounting periods, the Trust 12 issues its results of operations statements 46 setting forth the realized and unrealized total Intermediation Profits of its operations. Step 13a and 13b, blocks 50 and 52, illustrates settlement of the Prepay obligation and liquidation or termination of the Trust 12 activities, which would likely include final allocation of Intermediation Profit remainder. An optional phase of Trust 12 operations is shown in block 48 as Step 12. This optional phase includes provision for optional “re-opener” windows where the parties may reallocate future potential Trust 12 operating profits. Such a re-opener may be by the achievement of “milestones” by either of the parties, or simply by mutual agreement at pre-set review “windows”. In addition to a re-opener for profit allocation, the parties may wish to provide for material changed circumstances such as the COC Arbitrage has narrowed or gotten “upside down”—that is to say that the credit condition of the Vendor 10 may have materially changed over time such that it is now better than the Buyer 14. In this event a third party financial institution may opt to assume the Prepay from the Buyer 14; or, the credit worthiness of the Vendor 10 may be so improved that the parties are able to securitize the Buyer's Prepay with the Trust 12 simply by taking the Buyer 14 out through an IPO or private placement of securities. It can be seen that the Trust's structure and its operation will best be creatively tailored at inception by the parties and their advisors to provide for altered business climates. As in any business situation that is impacted by market conditions, whether product or credit, an evolutionary approach that can adapt to new or revised business conditions is highly desirable.

Returning to the basic functional concept of the BIP Trust as provided in FIG. 1, there are four basic default scenarios that must be considered in preparing Trust documents. First, the Vendor fails to deliver the product or service under the Contract. This would be a Contract default, which would likely be welcomed by the Buyer, as the Contract can be replaced with less expensive product or services under spot market conditions. However, the Buyer has prepaid for product and the Trust is holding bonds for product invoice settlement; therefore, the ability to replace the Contract may not be remedy enough; therefore, the Buyer should require that the Prepay be structured on a “top end” basis. In other words, the Prepay is for only a portion of the product price in excess of spot market and the remainder of the product price is not subject to the Prepay and is handled under normal invoice terms as delivered. The structure of the Prepay to provide for Buyer default remedies is probably the most challenging contractual aspect of the BIP Trust transaction and could involve solutions other than the “top end” prepayment. A specific industry example will be offered hereinafter to illustrate alternate Prepay structure that enhances Buyer's security position. Nevertheless, the parties to the BIP Trust transaction, as in the example offered later, must tailor their unique circumstances to moderate the default risk, so that the process can go forward and the benefits emanating from it can be realized and shared.

The second default condition would be if the Vendor fails to pay interest on the obligations held by Trust. As a precaution when structuring the Trust, the Buyer should require a Trust provision whereby the debt under interest default may be discounted at invoice settlement in order to offset the unpaid interest. Clearly, the prospect of dealing with any type Vendor default is probably the most important feature in crafting the Trust and Prepay documents. This default discussion is obviously for the set of circumstances where the COC Arbitrage favors the Buyer and the Supply Value favors the Vendor, making the Buyer default remedies easier to be dealt with because of the presence of this Supply Value. In this situation, while the Buyer may not be sacrificing default protections through the BIP Trust endeavor, it is certainly complicating them; therefore, the Buyer must be adequately compensated in its share of the Trust profits in order to fairly offset its compromise of Vendor default recourse.

In the case of potential Buyer defaults, the Vendor's recourse generally improves with the implementation of the BIP Trust. The first default condition would be if the Buyer fails to accept product or services. The Vendor is at least partially protected by the presence of the Prepay; or, at least the Vendor has added performance default protection remedies that he otherwise would not have had without the BIP Trust existence. The second Buyer default condition is if the Buyer fails to pay for product or services rendered. Here the Vendor is considerably more protected than if the Trust were not in place. Upon review of the four major default conditions that could occur, it is apparent that the BIP Trust increases Vendor remedies and does little to enhance Buyer remedies. Therefore, in recognition of this situation, the parties must structure the Trust profit division in a manner that reflects this balance—a classic risk versus reward scenario. Again, keep in mind the BIP Trust objective, which is to create an Intermediation Profit opportunity by matching debt maturities with Contract cash flows, such mechanism underpinned by the Supply Value. It is a share of these Intermediation Profits, which may be in the form of discounting invoices that induces the Buyer to participate in the BIP Trust.

The parties to a BIP Trust may wish to fashion a Trust that is more proactive in dealing with default risk, or in reducing the cost of a Vendor default. The Trust itself, empowered by its creating documents, may take action or devote some of its capital toward reducing the risks and costs of Vendor default by conducting hedge activities. For example, in the merchant power industry, where low prices would normally be complementary to the risks of a Vendor performance default because the power could be replaced at a reasonable price, if a Vendor defaulted because of high fuel prices this could make substitution more difficult. Therefore, it is possible to envision circumstances, where the parties to a BIP Trust may want to devote some of the Trust capital toward hedging activities that would enhance Buyer protections in the event of a Vendor default caused by downstream supply costs. The purchase of credit default swaps would be another example of a BIP Trust taking a proactive stance in dealing with default risk; however, it is unlikely that this would be a worthwhile expense because the same capital market conditions that undervalue the Vendor's Obligations or the Contract (and create the Intermediation Profit opportunity for the BIP Trust) would likely lead to excessive costs to procure these instruments.

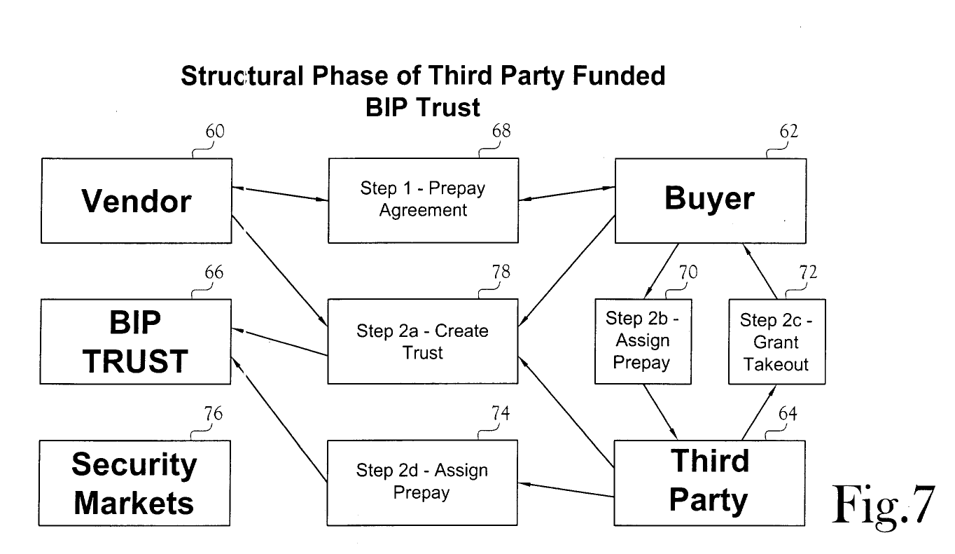

The Third Party funded BIP Trust, hereinafter “Third Party or Third Party Trust”, (FIGS. 7-11) may provide a superior alternative to the Buyer Funded alternative in many circumstances. A Third Party is defined as any party, other than the Vendor or Buyer, that contributes to the transaction, more than likely funding or expertise such as capital underwriting skills or Trust management, that facilitates the transaction, and could receive a share of the Intermediation Profits. By definition, the Third Party may be just one party or it may include the plural case of more than one party. The Third Party and the Third Party Trust will generally be characterized by the following. First, a Third Party Trust may offer a more favorable COC Arbitrage opportunity versus the Buyer due to a lower cost of capital. Secondly, a Third Party Trust may have a greater propensity to undertake risk in order to achieve superior return. Finally, the Third Party may simply bring financial expertise and/or capital raising ability to the transaction that the Vendor and Buyer require in order to consummate the BIP Trust transaction. Generally the following comments will describe the Third Party Trust as contrasted to the Buyer Funded base case.

In the Structural Phase shown in FIG. 7, the Third Party Trust case would require a trilateral agreement to create the Trust 78, as opposed to a bilateral agreement for the base situation; furthermore, the assignment 70 and 74 of the Prepay agreement 68 could likely require an additional step. The illustrated case proposes a “takeout option” 72 for the Buyer 62, in the event that the Vendor's credit worthiness improves or the risk profile of the Buyer 62 increases such that its appetite to take over the transaction reaches an acceptable threshold, in which event the Buyer 62 takes out the Third Party 64 and succeeds to his position.

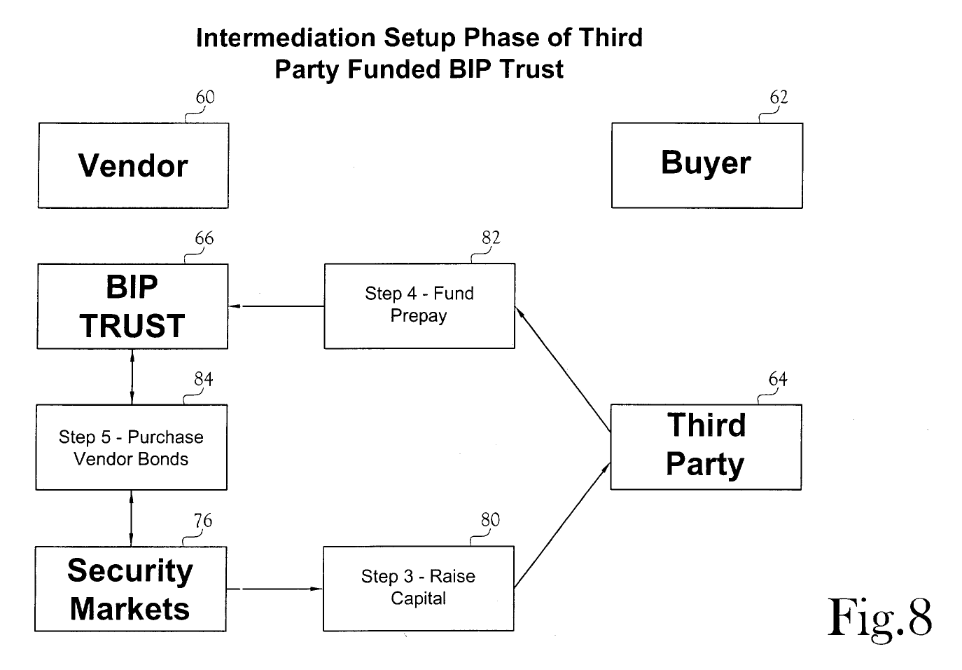

Progressing to the Intermediation Setup Phase shown in FIG. 8, this step is the same as for the Buyer Funded Trust. Thus, the method includes the steps of raising capital 80, funding the Prepay 82 and purchasing the vendor bonds 84. Similarly, the Third Party Trust may be a partner that has sufficient capitalization or funding capacity to handle the transaction without having to obtain funding from the securities markets 76.

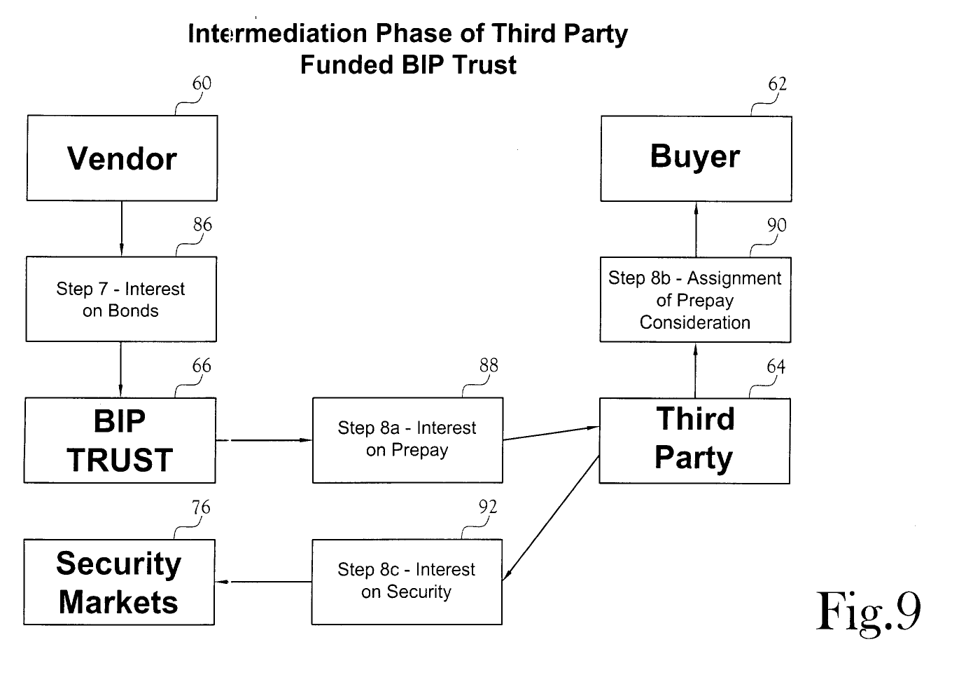

The Intermediation Phase shown in FIG. 9 has a similar progression of interest flow. The Vendor 60 pays interest on the bonds 86 to the BIP Trust 66, the BIP Trust 66 pays interest on the Prepay 88 to the Third Party 64, and the Third Party 64 pays interest on the securities 92 to the security markets 76. However, in the Third Party Funded situation, an optional payment 90 of intermediation interest is offered to the Buyer 62 as consideration of its Prepay participation. The BIP Trust will probably not get to first base without the consent and co-operation of Buyer 62; thus, the presentation in FIG. 9 recognizes this contribution. Furthermore, it is conceivable that a related party to either Vendor 60 or Buyer 62, such as a critical lender, may receive consideration, either directly from the Trust 66 or from one of its creators.

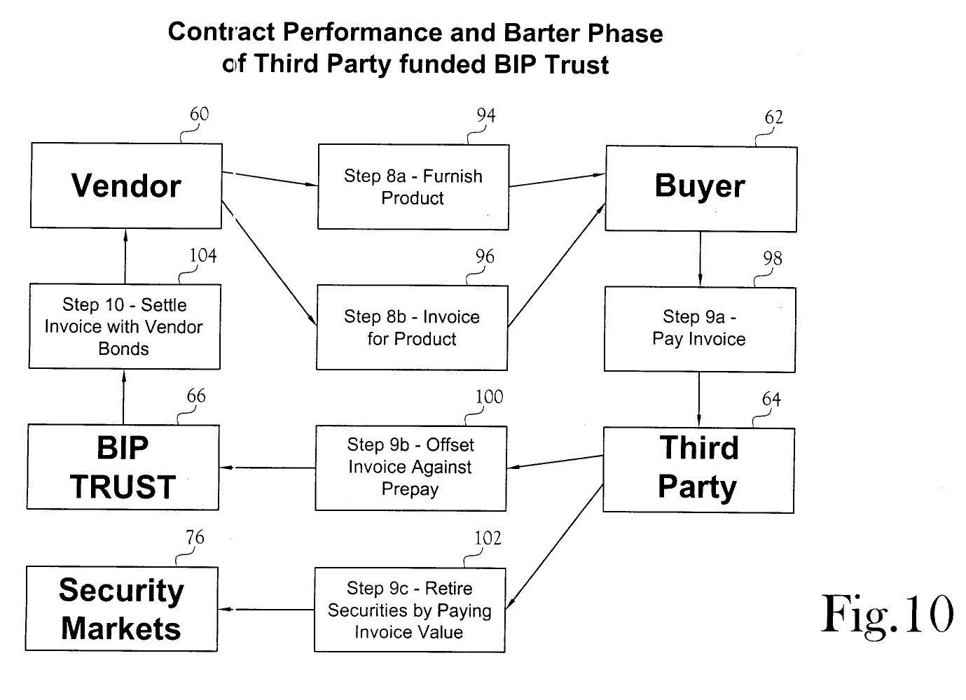

The transactional path of the Contract Performance and Barter phase in FIG. 10 is not the same as the base case, but is clearly presented in the figure. The Vendor 60 furnishes products 94 and invoices 96 to the Buyer 62. The Buyer 62 pays the invoices 98 to the Third Party 64. The Third Party 64 offsets the invoices against the Prepay 100 and retires securities by paying the invoice value 102. The BIP Trust 66 then settles the invoices with inventoried Vendor bonds 104. As discussed hereinabove, this phase offers numerous options with respect to the taking of discounts on invoices or bond maturity settlement that allow the BIP Trust parties the flexibility to direct Trust 66 cash flow to satisfy structural setup inducements.

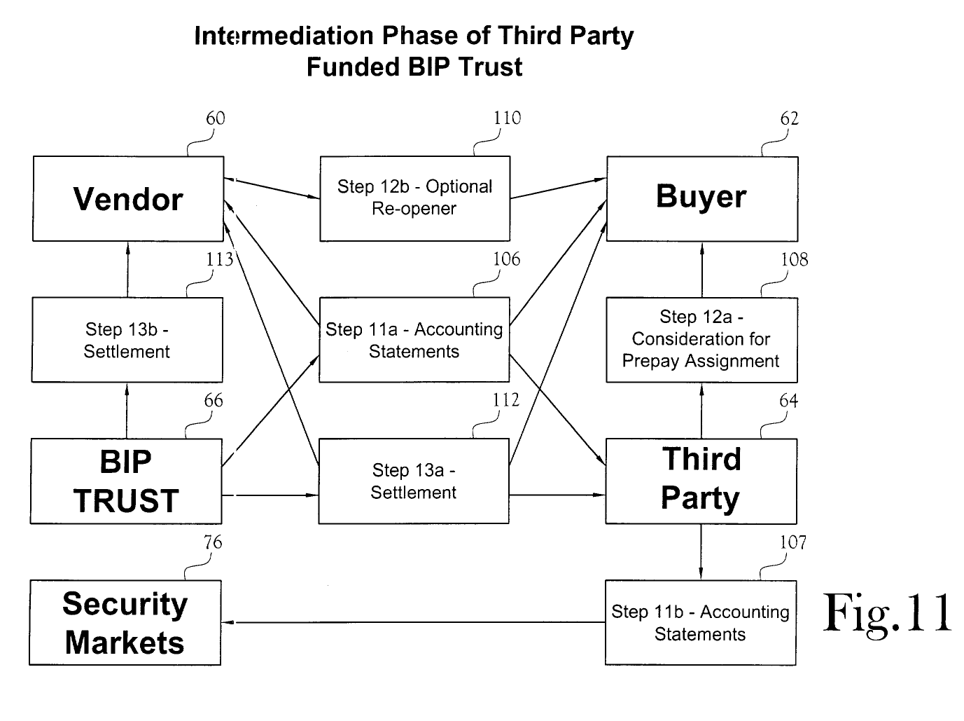

Finally, the Accounting/Settlement phase is presented in FIG. 11. This phase includes the steps of the BIP Trust 66 providing accounting statements to the parties 106, the Third Party subsequently providing statements 107 to the securities markets 106, the Third Party 64 providing the Buyer 62 consideration for the Prepay assignment 108, the Buyer 62 and the Vendor 60 establishing an optional re-opener 110 and the settlement of the proceeds 112/113 between the parties. Depending on how the Trust 66 is funded, it is likely that the Trust statements could also be required to flow to the security markets 76.

Recognizing the creativity of investment bankers and the financial community, it is possible that a myriad of other cases could be derived from the two basic BIP Trust building blocks. One such derivative case would be adding a BIP security (hereinafter “BIP Units”) to either of the foregoing cases with the BIP Units issued by the Buyer or Third Party; further, the BIP Units could be issued directly by the Trust under either of the two initial structure modes. The BIP Units could be debt, equity, hybrid securities, partnership interest, or a derivative or combination of the foregoing, either publicly or privately placed. For example, in the base case, where the Buyer raised capital from the security markets (FIG. 3) to initially seed the Trust, it is assumed that such capital securities are backed by the full faith and credit of the Buyer. As the Vendor's situation improves, the Buyer may want to replace his securities or even supplement his securities (for the purpose of enlarging the BIP transaction) with BIP Unites that are not backed by Buyer's credit, but are standalone securities issued on the strength of the BIP Trust transaction and ultimately underpinned by the Contract relationship and its performance. The definition of BIP Units shall further include the alternative or supplementary case where the BIP Units are funded, in whole or in part, through an exchange offer of Vendor Capital Obligations (as hereinafter defined).

By issuing BIP Units, some of the BIP Trust transactional risks may be passed directly on to the capital markets. The issuance of BIP Units could be a stage two progression alternative to either expand the trust's intermediation capacity or replace the capital issued by the Buyer or a Third Party because the Trust would have developed an operating history and the market may have gained greater comfort with the Vendor's business and/or the sanctity of the Contract. BIP Units could also serve the purpose of a party “taking profit” out the transaction. Essentially, the BIP Units offer the Buyer or the Third Party the future possibility of replacing its capital raising capacity with capital where the market is taking more of a transparent risk on the success of the BIP Trust and the Contract performance. It is the purpose of this Trust derivative concept to highlight some of the structural alternatives that could make the BIP Trust concept more feasible for participants engaged in a Contract relationship that the markets have severely undervalued, as manifested in depressed bond prices of the Vendor.

There are other derivative or creative options of the BIP Trust transaction. First, in the case of the issuance of BIP Units, such offering could be done in conjunction with the direct exchange, either on a fixed exchange rate or Dutch auction type exchange, for Vendor “Capital Obligations or Obligations”, hereinafter defined as any Vendor security that bears interest or a dividend and/or has a set redemption or “put” date which could include, but not be limited to, bonds, preferred stock, convertibles, zero coupons issues, or other hybrid securities. By definition, Capital Obligations or Obligations or either modified by the term Vendor shall be used interchangeably. Second, when dealing with the issue of a liquidity penalty created by the difficulty in precisely matching Obligation maturities with Contract cash flows, if the Trust profits are sufficient, then Obligations that are subject to early redemption may be utilized to fully exploit the Trust profit potential. Further, a lender may require a “piggy back” of his Obligation retirement should the Vendor's share of the Trust profits or bond barter discounts be sufficient. Third, in special “one-sided” Contract situations, where either the Vendor or Buyer has strong and adequate rights, the BIP Trust might be implemented unilaterally by one or the other. In the case of the Vendor, it would almost certainly require funding by a Third Party or with the assistance of a Third Party using BIP Units to accomplish the funding. In the case of a unilateral agreement by the Buyer, strong “setoff” rights may be necessary to effectuate the invoice settlement using Vendor Obligations in barter. Again, the BIP Trust concept is intended to exploit a Contract having Supply Value, generally to the excess, and the security markets have not reflected such Supply Value in the price of the Vendor's Capital Obligations. Generally the BIP Trust structure will require both the Vendor and Buyer to cooperatively structure it in order to capture this value from the securities markets, but in rare circumstances this may not always be the case.

An excellent example of a “Vendor Unilateral” BIP Trust (hereinafter defined as a Trust established without the direct participation of the Buyer) would be the case of a strategically located power plant, where its Contract, although informal in nature, is derived from a strong competitive position relative to the cost of fuel (coal versus natural gas) or maybe a lack of generation or transmission capacity in the immediate geographic area. Nevertheless, even though its Contract may not be formal in nature with a “named” Buyer, it has a secure enough market position such that its future output has Supply Value by virtue of its competitive position. In this case the BIP Trust could be established with a Third Party acting as agent under the Trust Agreement and the Prepay would be funded either by the Third Party, or more than likely, using BIP Units. While the Supply Value may be lower than a situation involving a form a Contract with a Buyer, the absence of the Buyer's participation in the subject arrangement, the COC Arbitrage need only be share between the Vendor and capital markets; thus, providing greater return potential for the Vendor and it creditors. In the event that a creditor group already has a secured interest in the instant power plant, then such party(s) may be an indirect participant in the transaction. Naturally, the invoice flow would need to be modified to reflect the secured interest of the BIP Unit holders in the specified future output under the Prepay. The foregoing example illustrates the complementary nature of the Supply Value and the COC Arbitrage; furthermore, the adaptable nature of the BIP Trust is well demonstrated here.

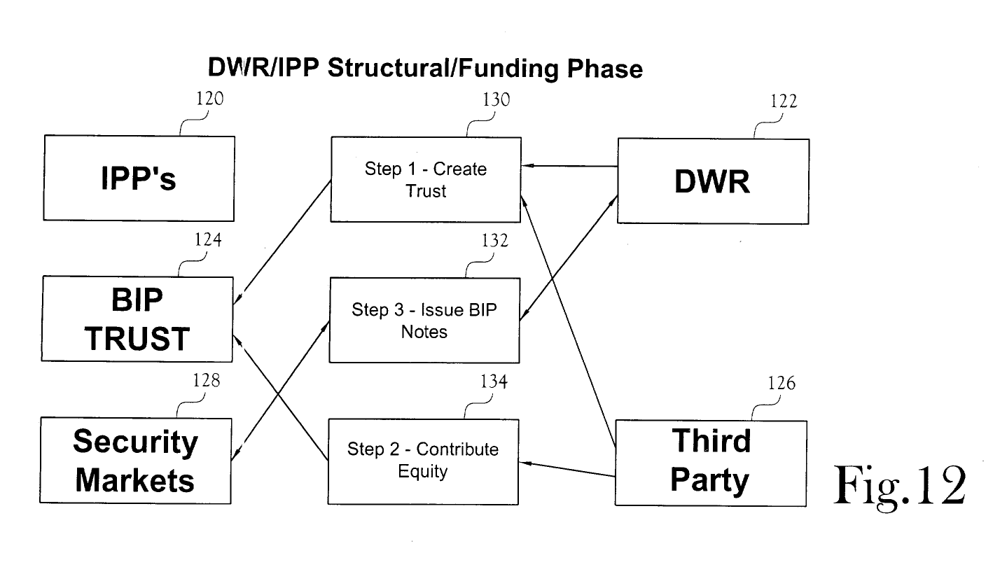

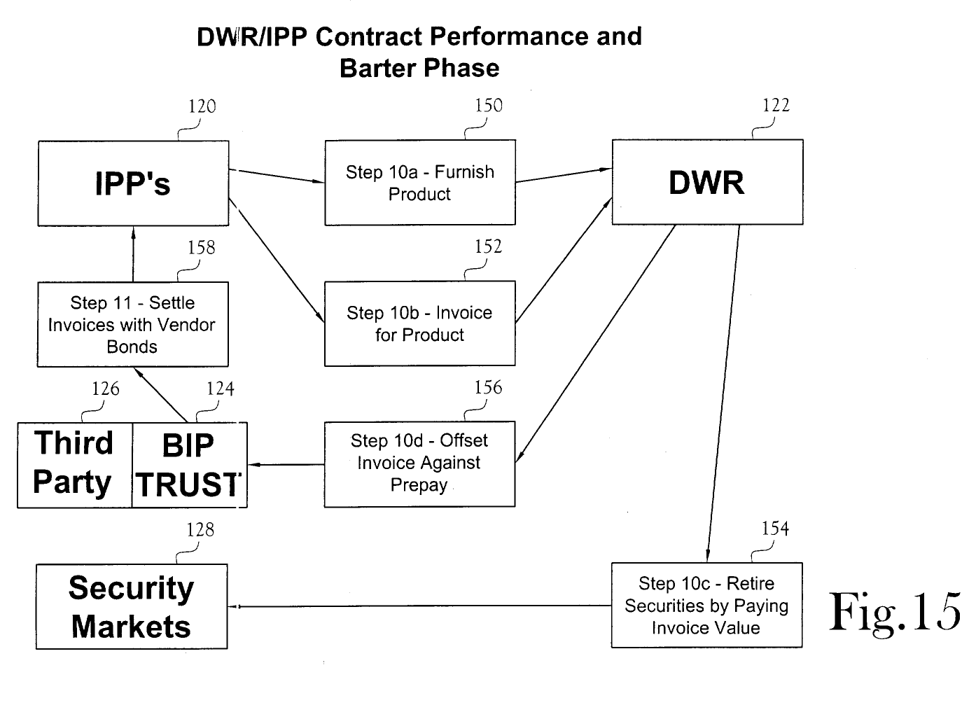

The merchant power generation industry provides an excellent example of a fertile BIP Trust application with some creative twists; furthermore, it illustrates that the BIP Trust process is a concept to capture Intermediation Profits that is as flexible as its creators allow, not highly structured by design, and impossible to describe all the various structures and options because of the unique characteristics of each situation. FIGS. 12 through 16 provide an approach for the California Department of Water Resources (DWR) 122 to create a synergistic opportunity with the independent merchant power generators (IPPs) 120 that hold approximately $45 billion of contracts for power delivery having Supply Value of roughly $20 billion. These Contracts were structured in a crisis environment and in far more favorable power market conditions than what presently exists; thus, the reason for the high proportion of Supply Value relative to the total Contract value. What was appropriate under conditions two years ago now presents an attractive opportunity because these Contracts have such high Supply Value; moreover, the BIP Trust opportunity is heightened because the IPP 120 Vendors under these Contracts have Capital Obligations selling at extremely depressed prices (40% and 50% discounts). The fact that this Supply Value may not be reflected in the IPP Obligations does not deter its use to capture the COC Arbitrage through the use of a Prepay.

The following example provided offers only one of several possible approaches to a situation where DWR 122 may lower the cost of power through the use of the BIP Trust 124. In this embodiment of the Trust application, Step 1 of the Structural/Funding Phase (FIG. 12) proposes that DWR 122 enlist a Third Party 126, likely an investment bank, consulting firm, or other financial institution, to enter into a bilateral agreement 130 creating the Trust whereby the Third Party 126 commits to a level of equity funding 134 of the Trust in exchange for the Trust management role. In return, DWR 122 commits to raise capital 132 from the security markets 128 in the form of BIP Units, which will be used to fund the Prepay and are transparent with respect to the transaction (they do not rely upon DWR's credit, are not guaranteed by DWR, but do rely upon DWR's Contract performance—such BIP Units rely solely upon the success of the BIP Trust transaction and its reliance upon the Contract).

The BIP Units would represent the funding for a “top end” prepay (assuming a cost per MWHr of $60, then that portion from $41 to $60 per MWHr or the top third of the price), and DWR 122 commits to pay the BIP Unit holder that amount for specific future blocks of power, to be determined following the “Auction”, when the power is delivered under the Contract or otherwise procured by DWR 122. Aside from the obvious competitive benefits of an auction, the multi-party approach provides the opportunity to more efficiently employ the Trust 124 capital by having a broader group of Contracts to match with IPP Obligation maturities. It also offers the benefit of diversity from the standpoint of Contract performance and capital markets risk assessment. The issuance of the BIP Units and escrow of the proceeds prior to the auction is proposed in order to show the field of Vendors that DWR 122 and the Security Markets 128 are committed enough to the transaction to pre-fund it. Another significant advantage of pre-funding is that this gives DWR 122 and the Third Party 126 a concrete intermediation cost yardstick with which to conduct the auction. The downside of the pre-funding is that it would likely rally Vendor Obligations somewhat, which would diminish intermediation opportunity; however, that phenomena would occur anyway if the Prepay agreement preceded the Trust funding as it normally would; furthermore, any capital raising activity will likely be an SEC registered transaction, or if privately placed, would be with a registered entity, so the capital markets will be alerted under any BIP Trust scenario prior to Vendor Capital Obligation purchase activity.

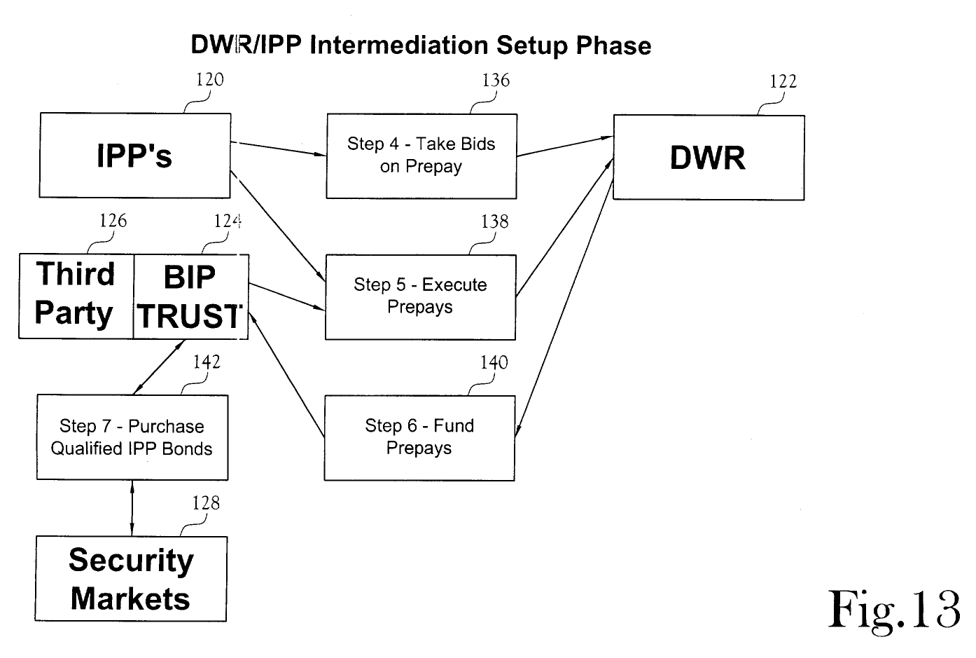

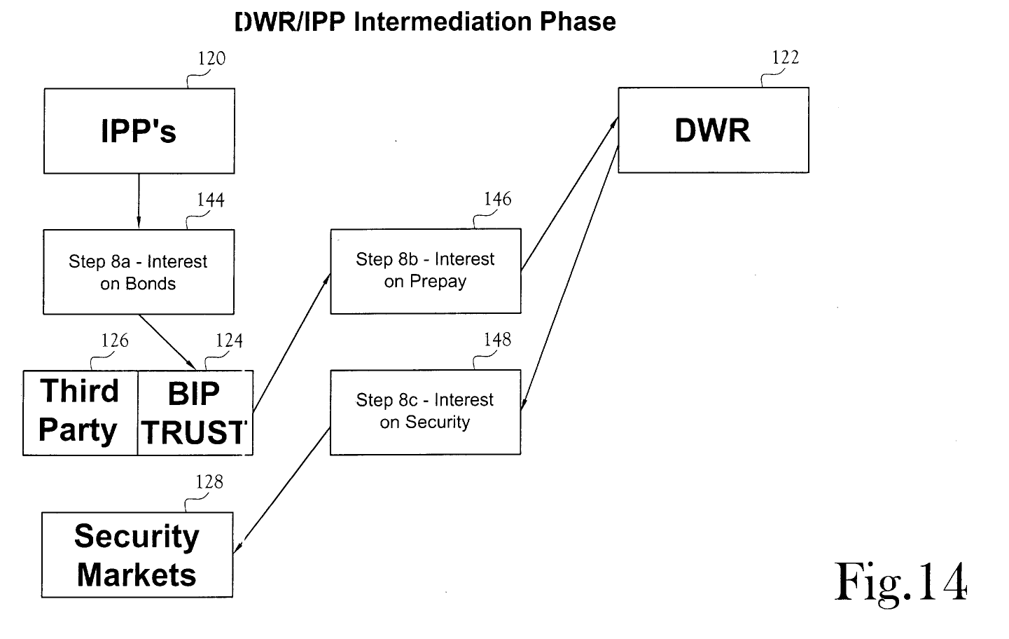

The Intermediation Setup Phase is presented in FIG. 13. The Third Party “block” 126 has been relocated in the figure next to the BIP Trust “block” 124 to indicate its position as manager of the Trust operations. At a $3 billion funding level of the Trust 124, DWR 122 would need to receive responsive bids from IPPs 120 for approximately seven percent of the potential power under the Contracts, and such power would need to be approximately matched to Vendor Obligation maturities. Basically the auction in Step 4 136 would be to determine what level of Intermediation Profit share, both on the interest and capital gain pieces, that the IPP Contract participants 120 would be willing to offer DWR 122 to participate in the Prepay. Based on pre-established criteria including economic potential, credit profile, etc., the DWR 122 would award the bids and execute Prepay agreements 138 with the successful Vendors, then assign these to the BIP Trust 124. The Prepay would authorize DWR 122 such that if there were a performance default or a Capital Obligation default, then DWR 122 would have the right (which it likely already does under the Contracts) to purchase the power on the open market. The risk to the BIP Unit holders, assuming that the BIP Units are directly linked to this transaction, is that DWR 122 is unable to procure the power for less than two-thirds of the Contract price (or one minus the reciprocal of the top-end fraction, whatever it is). The most likely cause of IPP 122 default would be severely low spot market power prices which is complementary to the BIP Unit default risk scenario (the risk of not being able to replace power at better economics is low). Following Prepay execution in Step 5 138, the DWR funds the Trust 140 with the escrowed BIP Unit proceeds, then the Trust commences purchasing auction qualified IPP Bonds 142. FIGS. 14 through 16, which represent the Intermediation Phase, Contract Performance and Barter Phase, and finally the Accounting/Settlement Phase, respectively, are straight forward and generally follow the progression of either the Buyer Funded or the Third Party Funded BIP Trusts.

The following provides an excellent alternative to the “top end” Prepay method for promoting default protection. DWR's present portfolio of Contracts consists of a situation where the DWR has an aggregate “net long” power position for extended periods over the calendar and for extended times during the day (either an excess of off-season power or an excess of off-peak load power). Thus, it may be advisable to construct the Prepay using these net long power deliveries because the risk/reward tradeoff may be more favorable using time-of-season or time-of-day in the Prepay structure, as compared to the suggested “top end pricing” method. Given the total Intermediation Profit potential and the obvious potential to obtain attractive power purchase discounts through the BIP Trust mechanism, it is highly likely that a clever Prepay structure would produce a state of no additional risk to the DWR (or where the reward so far over balances the risk, and the BIP Unit holders are willing to assume this risk for a piece of the reward, that there is effectively no additional risk to DWR). This specific industry example points out how the BIP Trust must be uniquely tailored to the situation at hand. Furthermore, the foregoing example demonstrates that the DWR and its Contract merchant generators possess the opportunity to capture significant profits, from the financial markets, for their power consumers and shareholders respectively; yet, because only the Trust participants are in the unique position to appreciate and capture these profits, it will require a strong mutual effort to fashion the BIP Trust that best seizes this opportunity. From the Security Markets 128 perspective, the very act of structuring the BIP Trust would likely promote Contract sanctity, or least, perceived Contract sanctity.

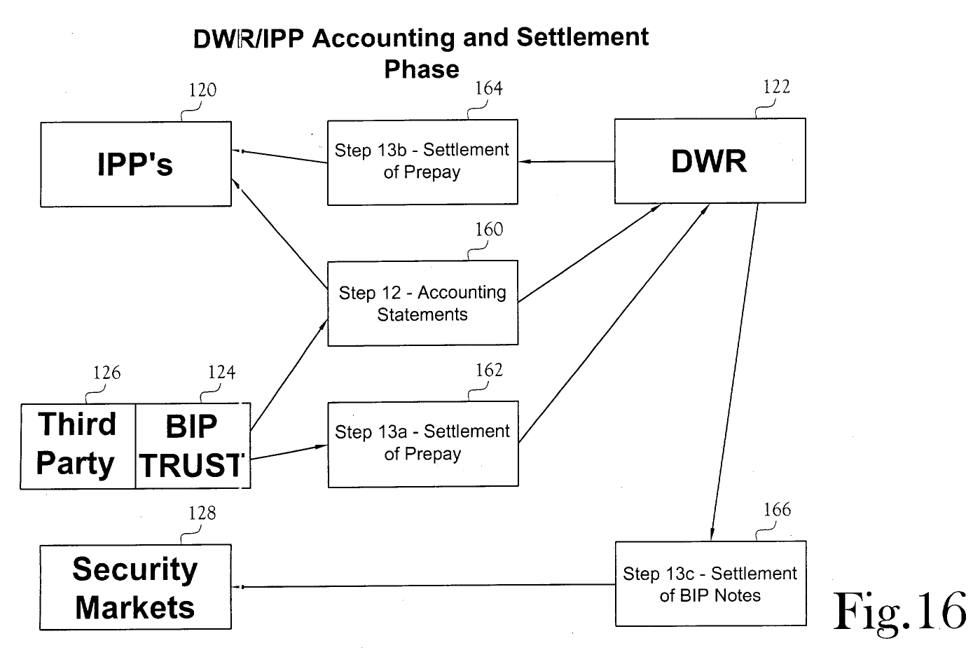

An estimate of the possible profits of the California power application is provided below in Table 3. However, before reviewing this table, a discussion of “funding types” would be appropriate. All three of the previous examples (Buyer Funded, Third Party Funded, and IPP/DWR Trust) represent examples where the BIP Trust was “transactional funded”; in other words, when the invoice was due to be paid by Buyer, the cash transfer was directed to settle the prepayment funding from its original source (Step 10b in FIG. 5, Step 9c in FIG. 10, and Step 13c in FIG. 16). This BIP Trust structure was offered because it is conceptually the simplest to link funding to the commercial transaction for purposes of default protection and credit risk; thus, the term transactional funded. The case where the parties may agree to a “time funded” approach offers the potential to recycle the Trust funding when the Vendor Obligation maturities and Contract term allow multiple turnovers of BIP Trust funding. For example, with the California power purchase Contracts, the BIP Units could be issued for a period of eight years (instead of being linked to only one specific power transaction) and employed for two four year cycles (or a two year and six year, etc.) to increase funds turnover through the linkage to a progression of power transactions. Invoice payment by Buyer in the first cycle would go to the Trust with the execution of a second Prepay to be used for purchasing another Vendor Capital Obligation, then four years later invoice payment would go to the funding source. In both the first and second four year cycle, the Trust would use the Obligation to settle the invoice with the Vendor.

For purposes of the definition of Prepay, it is thus enlarged to include, in the alternative to the “transactional funded” case, the “time funded” case, which selection will depend upon business factors of the parties involved in the BIP Trust transaction. Also as explained previously, the Prepay shall be further defined as being funding from any of or a combination of the Buyer, a Third Party, BIP Units, or in the case of the Vendor Unilateral Trust, by the Vendor through the use of one of the foregoing. Such funding alternative shall be to maximize the COC Arbitrage value or for other valid business reasons.

Calculations in Table 3 assume such a time funding basis as opposed to a transactional funding basis, and reveal the dimension of the profit opportunity available to DWR and its IPP merchant generators. The two columns are intended to illustrate the impact that IPP Capital Obligation discounts and any assumed improvement on IPP expectations have on the potential Intermediation Profit level. The left column calculates the profit potential at the inception of the transaction assuming 40% Obligation discounts; whereas, the right column assumes some improvement in IPP prospects and uses a 25% discount level.

TABLE 3
BIP Trust - DWR/IPP Pretax Profit Projection

| | Inception | Lifetime |
|---|---|---|
| Assumptions: | | |
| Trust Funding (mils) | $3,000 | $3,000 |
| Coupon on IPP Bonds | 8.50% | 8.50% |
| Discount on Bond Purchase | 40.0% | 25.0% |
| Cost of DWR Funding | 7.00% | 7.00% |
| Turnovers of Trust Funding | 2 | 2 |
| Capital “employed” ratio | 95.0% | 95% |
| Post Maturity Avg. Bond Inventory Period (days) | 45 | 45 |
| Number of Years Trust Operational | 8 | 8 |
| Annual Trust Operating Costs including | $5.0 | $5.0 |
| amortized setup (mils) | | |
| Bond inventory cost on DWR rate - Annualized | 0.88% | 0.88% |
| Calculations: | | |
| Purchase Yield on IPP Bonds | 14.17% | 11.33% |
| BIP Trust Intermediation Spread versus DWR | 7.17% | 4.33% |
| Rate | | |
| Average Capital Employed (mils) | $2,850.0 | $2,850.0 |
| Intermediation Pretax Profit per year (mils) | $204.3 | $123.5 |
| Average Bond Holding Period (yrs) | 4 | 4 |
| Average Capital turnover per year (mils) | $712.5 | $712.5 |
| Coupon Value of Bonds “bartered” each | $1,187.5 | $950.0 |
| year (mils) | | |
| Avg. capital gains realized on bonds per | $475.0 | $237.5 |
| year (mils) | | |
| Annual Bond Inventory Cost (mils) | $24.9 | $24.9 |
| Avg. Annual Pretax Profit (mils) | $649.3 | $331.1 |
| Total BIP Trust Life Cycle Pretax Profit (mils) | $5,194.5 | $2,648.5 |

Note:
The term “Bond” is used synonymously for Capital Obligation.

Looking at the feasibility of this transaction and the specific assumptions in Table 3 indicates that under fall 2002 market conditions the estimate of a $3 to 4 billion profit (pre-tax) on $3.0 billion funding should be a reasonable goal to achieve. For instance, one IPP alone has over $8.0 billion of Senior Notes payable that mature between 2004 and 2011; however, the term on its renegotiated DWR Contracts generally mature during the same time frame, or between 2009 and 2011. Almost all of the IPP's senior notes have coupon rates above 8%, so it is believed that the Line 2 assumption is conservative. The present discount on a few of the DWR long term power suppliers, is in the 50 percent or greater range for medium to longer term maturities; therefore, even with some appreciation due to BIP Trust Obligation purchase activity and market price anticipation, the assumed purchase discount of 25% is believed to be conservative. At an average purchase discount of 35%, the pretax Intermediation Profit, net of Trust operating costs and amortized setup costs, remains above $4.0 billion as calculated in Table 3. The purchase discount assumption of 25%, while it may appear overly optimistic now, does allow for an improvement in IPP prospects plus the possibility of some BIP Trust Vendor defaults that would offset the very low Obligation prices available in the market at September 2002. The assumed cost of DWR funding through the sale of BIP Units would appear high relative to existing municipal rates (this transaction would likely not be tax exempt), but in view of “post Enron paranoia” plus the novelty of this transaction, it is believed that a higher than market rate is appropriate. In the eight year Trust term, it is assumed that the trust capital “turns over” an average of twice, or about every four years.

Probably the least conservative assumption is the 45 day “post maturity bond holding period” which occurs because the Trust must hold IPP Capital Obligations that generally mature once per year to settle invoices that would be recurring monthly or seasonally, depending on Prepay structure. Based upon the foregoing and other assumptions shown in Table 3, the computation of $2.6 billion of BIP Trust lifetime pretax profits for the transaction participants would attainable; further, the Table 3 presentation assumes that none of the Trust profits are retained, which could compound earnings potential, but that earnings are paid out annually.

State and Federal income taxes impact the structure of most business transactions and will obviously impact the BIP Trust structure. The parties may deal with the tax issue in at least three ways: first, the type entity that is used to create the Trust such as “C” corporation or “Subchapter S” corporation, etc.; second, the manner in which invoice payment is made by Buyer to the funding source; or, third, the manner in which invoice settlement with Capital Obligations is performed by the Trust with the Vendor. For example, because of other valid business issues (default protections, credit risks, etc.) the parties may not be able to create the Trust with the most efficient tax structure and the parties may be unwilling to postpone Trust profit share participation until liquidation or dissolution; therefore, in the case of the Vendor, Obligation discounting could be allowed by the Trust when the Obligations are bartered for invoice settlement. Clearly, the number of ways that the parties may devise to recognize profit (or direct cash flow) from a tax standpoint will depend upon the tax circumstances of the individual parties and will need to be incorporated into the Trust in the original structuring phase. The financial community has created numerous ways for individuals, corporations, and other entities to avoid or defer paying taxes and the BIP Trust may be a means of furthering that goal; however, the primary purpose of the BIP Trust is not to create cash flow and profits by avoiding taxes but to capture Intermediation Profits that are not fully appreciated by the financial community. In the process of generating these profits, naturally the parties to a BIP Trust should give consideration to structuring the transaction in the most tax efficient manner possible, keeping in mind that this is only one of many important business issues that concern Trust structure.

While a preferred embodiment has been shown and described, it will be understood that it is not intended to limit the disclosure, but rather it is intended to cover all modifications and alternate methods falling within the spirit and the scope of the invention as defined in the appended claims.

I claim:

1. A method of capturing value from a Vendor's discounted Capital Obligations that do not adequately reflect the Supply Value of a Contract between said Vendor and a Buyer, said method comprising:
establishing a BIP Trust under a Trust agreement to accept a Prepay relating to said Contract;
funding said Prepay with funds from a funding party or from BIP Units;
using said Prepay funds to purchase Capital Obligations of said Vendor on a discounted basis to capture a difference between a higher cost of capital of said Vendor and a lower cost of capital of said funding party or BIP Units;
holding said Obligations to realize Intermediation Profits;
using the Buyer's payment of invoices issued pursuant to said Contract to repay said funding party or BIP Units;
settling Contract invoices with Vendor using the Capital Obligations of said Vendor;
reopening, if changed conditions so warrant or in the event of defined circumstances, the BIP Trust agreement or the Prepay agreement to provide for such changed conditions or circumstances; and
accounting for and assigning said Intermediation Profits in accordance with said Trust agreement.

2. A method of arbitraging a cost of capital differential between a Vendor and a funding party, or between a Vendor and BIP Units, said method comprising:
during a prepayment phase, a BIP Trust is established to accept Prepay funds based upon the cash flows of a Contract between a Vendor and a Buyer, said funding party being selected from a group comprising said Buyer, a Third Party and BIP Units, and to acquire Capital Obligations of said Vendor;
during an intermediation phase, said Trust captures an interest spread, based upon said differential cost of capital between a Vendor and the funds provided pursuant to the Prepay, and earns capital gains on Capital Obligations of the Vendor when intermediated by said Trust; and
during a barter phase, Vendor invoices issued pursuant to said Contract are discharged by the Buyer paying the funding party and said Trust bartering said Capital Obligations of said Vendor in settlement of said invoices.

3. A method of doing business, as an alternative to monetization of a contract between a Vendor and a Buyer, to realize Supply Value in said Contract through the use of a Cost of Capital Arbitrage, said method comprising:
establishing a Trust to intermediate between said Buyer and said Vendor to perform arbitraging and bartering steps to earn Intermediation Profits.
establishing a Cost of Capital Arbitrage through a Contract Prepay funded by a funding party, which may include the use of BIP Units, to purchase Capital Obligations of said Vendor;
directing payments by said Buyer, pursuant to Contract invoices, to said funding party;
reducing the amount of the Prepay credit as invoice payments are transmitted to the funding source; and
bartering said purchased Capital Obligations in settlement of invoices issued by said Vendor pursuant to said Contract;

4. A method of doing business comprising:
establishing a BIP Trust for the purpose of earning Intermediation Profits;
funding said Trust with a Prepay from a funding party or from BIP Units or some combination thereof;
acquiring in said Trust the rights to cash flow originating under a Contract between a Vendor and a Buyer;
acquiring Capital Obligations of said Vendor by said Trust;
repaying said funding source or BIP Units for the Prepay funds using payments from said Buyer pursuant to invoices issued under said Contract;
satisfying invoices issued by said Vendor through the barter of said Capital Obligations;
replacing or supplementing the funding source, in the event that more favorable funding opportunities arise or that the parties to the Trust and Prepay wish to expand the transaction; and
accounting for and distributing said Intermediation Profits.

5. A method of doing business using a BIP Trust to capture Intermediation Profits from a Vendor's undervalued Capital Obligations by funding a Prepay using Supply Value inherent in a Contract between said Vendor and a Buyer, said method comprising:
said Vendor establishes a BIP Trust that has rights to Vendor's cash flows under the Contract;
a Third Party or BIP Units funds a Prepay;
said Trust acquires Vendor Capital Obligations for the purpose of earning Intermediation Profits;
said Buyer's payments for invoices issued under the Contract are assigned to said funding source or BIP Unit holders; and
invoices issued by said Vendor are discharged by the Trust bartering said Capital Obligations in settlement.

6. A method of doing business using a BIP Trust to capture Intermediation Profits from a Vendor's undervalued Capital Obligations by funding a Prepay using Supply Value inherent in a Contract between said Vendor and a Buyer, said method comprising:
said Buyer establishes a BIP Trust using its setoffs rights in a Contract, which Trust would have rights to Buyer's cash payments for invoices issued under the Contract;
the Buyer, a Third Party, or BIP Units funds a Prepay using, as the basis for gaining the funding, the rights to the Buyer's cash payments for Vendor invoices issued under said Contract;
said Trust acquires Vendor Capital Obligations for the purpose of earning intermediation Profits;
said Buyer's payments for invoices issued under the Contract are assigned to said funding source or BIP Unit holders; and
invoices issued by said Vendor are discharged by the Trust bartering said Capital Obligations in settlement through the use of the setoff rights so held.

7. The method of claims 1 through 6 and further comprising a party otherwise unrelated to the method sharing in the Intermediation Profits as a result of facilitating the method.

8. The method of claims 1 through 6 and further comprising a funding progression or funding expansion, in any order or combination, of two or more funding sources selected from the group comprising said Buyer, a Third Party, and BIP Units
